(19) United States
(12) Patent Application Publication
(10) Pub. No.: US 2020/0070055 A1
(43) Pub. Date: Mar. 5, 2020

(54) METHOD AND DEVICE FOR GENERATING GAME PATHS

(71) Applicant: Beijing Shenji Intelligence Technology Co. Ltd, Beijing (CN)

(72) Inventors: Yu DU, Beijing (CN); Xiao HOU, Beijing (CN); Heng MA, Beijing (CN); Xianghao GUO, Beijing (CN); Cong CHEN, Beijing (CN)

(21) Appl. No.: 16/365,636

(22) Filed: Mar. 26, 2019

(30) Foreign Application Priority Data
Aug. 30, 2018 (CN) 2018110009674

(51) Int. Cl. A63F 13/56; A63F 13/47

(52) U.S. Cl. CPC A63F 13/56; A63F 13/47

(57) ABSTRACT

The present disclosure relates to game path generation and may include a main path generation step that includes selecting one position within a predetermined area coverage of a game map to be a starting point, selecting an initial departure direction, performing a path random search and generation step using arcs and straight lines which are connected smoothly, and recording a generated path as a main path, until a map boundary is reached. An additional branch path generation step may include randomly selecting one point within a predetermined range of the generated main path as a starting point of a branch path and an intersection point with the main path, selecting a direction intersecting with the main path as an initial departure direction of the branch path, performing a branch path random search and generation step using arcs and straight lines, and recording the generated path.

### CROSS-REFERENCE TO RELATED APPLICATION

This application claims priority to Chinese Patent Application No. 201811000967.4, filed on Aug. 30, 2018, which is hereby incorporated by reference in its entirety as if fully set forth herein.

### TECHNICAL FILED

The present disclosure relates to computer technologies, in particular to a method and a device for generating game paths.

### RELATED ART

As a strategy game, a Tower Defense Game attacks and prevents enemies from going forward by building towers or similar buildings on a map, so as to protect headquarters of players. This game is well-liked by players due to its characteristics of an increased game difficulty, an increased exciting degree and more challenge as the game progresses.

In the Tower Defense Game, the design of the map, particularly the design of paths in the map, is very important. According to settings of the game, monsters will go forward along a predetermined path, therefore the direction and shape of the path decide a defense difficulty to a great extent, thereby influencing practicability and thrill of the current level of the game. In a process of producing a traditional Tower Defense Game, the design of its map undergoes steps of background planning, path designing, Guard Tower spots (or referred to as tower pits) designing, art designing, or the like. With respect to the configuration of a specific level, the design of its map may further include the step of design and balance adjustment where a numerical game designer quantizes attribute fighting capacity of a guard tower and monsters. In such a complete process, due to a large number of participants and types of work, the game path design and the game production are very inefficient, the design period is too long and the game content is not sufficient.

In the traditional Tower Defense Game, paths are usually generated by a method of direct loading. The direct loading method is to design map data (including the path data) in the game level by a designer in advance, and then to load by calling related data directly when the game is running. This is the most direct path design method, and the path may be loaded rapidly when the game is running. However, on the one hand, the game path is fixed. On the other hand, in view of actual production efficiency, since the method for generating paths of the Tower Defense Game which is loaded directly needs professional designers to perform debugging and adjustment repeatedly, the time taken to design the path tends to be long, and many people and other resources are wasted, which greatly reduces an overall production efficiency of the game. In addition, the storage of the path data which is designed in advance needs to increase a storage space for the game data, such that the game portability is reduced.

In the production of some other types of games, a PCG (Procedural Content Generation) technology may be used to produce the game content by computers. The PCG technology may generate game contents such as levels, maps and monsters automatically as the game progresses according to a certain design rule, and may perform permutation and combination of some game contents by a random seed and a series of parameters adjusted by the designer, so as to produce “new” contents.

Although the PCG technology may prolong the game time and increase the game uncertainty to some extent, there are lots of problems. Most dynamic generation algorithms are too complicated and are executed with a low efficiency. Since the PCG technology is based on game parts designed by the designer, the generated content actually has certain limitations. They are permutations and combinations of limited elements, and the players would play all these elements quickly and lose feeling of freshness in new contents. Therefore, after a long period of time of playing the game, the generated game content will give the players a feeling of “combating with unlimited random numbers” , which not only cannot bring the feeling of freshness, but also makes the players disgusted with the repeated game content.

Besides, due to randomness, the balance of the game would be affected to a large extent. For example, properties of characters or equipment in the game are generated randomly, which is originally to provide “unlimited possibilities” for the players. However, in the game design, in order to make an equipment library/character library huge, complicated and difficult to repeat, the developer tends to set the random range too broadly. The over use of randomness may cause the game result to seriously depend on the random factor itself, instead of on factors such as human strategy and control. In order to maximize profit, the players would read stored files repeatedly to produce a specific random event, until the situation matching with the player's psychology is produced. These problems may come down to abuse of randomness. Actually, the over-low random number tends to be considered as “punishment” for players by exerting a negative influence. However, in the game playing, the players should not be punished due to “a black face”, but should be punished due to bad things he or she did.

Therefore, there is needed a method for generating paths of a game automatically by a computer instead of human.

### SUMMARY OF THE DISCLOSURE

In view of the above-mentioned problems in the related art, embodiments of the present disclosure are directed to providing a method and a device for generating a game path, that substantially obviate one or more defects in the prior art and at least provide an advantageous selection.

In order to realize the above object, the embodiments of the present disclosure provide the following aspects.

According to one aspect of the present disclosure, a method for generating a game path is provided, including a main path generation step and at least one branch path generation step. The main path generation step includes: selecting one position within predetermined area coverage of a game map to be a starting point, selecting an initial departure direction, performing a path random search and generation step using arcs and straight lines which are connected smoothly, and recording the generated path as a main path, until a map boundary is reached. The branch path generation step includes: randomly selecting one point within a predetermined range of the generated main path as a starting point of a branch path and an intersection point with the main path, selecting a direction intersecting with the main path as an initial departure direction of the branch path, performing a branch path random search and generation step using arcs and straight lines which are connected smoothly, and recording the generated path as a branch path.

In one embodiment, the predetermined area coverage of the game map is in the middle of the game map; the main path generation step further includes: after the generated main path reaches the map boundary, performing a path random search and generation step using arcs and straight lines which are connected smoothly from the starting point along a departure direction opposite to the initial departure direction of the generated main path, such that the main path extends from the starting point, until the map boundary is reached again.

In one embodiment, the step of performing path random search and generation using arcs and straight lines which are connected smoothly in the main path generation step or the branch path generation step comprises: a path search step, for generating a segment of arc or straight line along the current departure direction; and a pruning strategy optimization step, for determining whether the generated arc or straight line meets the predetermined pruning condition; if yes, the latest arc or straight line is undone, and the path generation step is performed again.

In one embodiment, the pruning condition includes: coinciding or intersecting with the existing path.

In one embodiment, the pruning strategy optimization step further includes: deleting a path if the number of times of undoing arcs or straight lines in the process of path generation exceeds a predetermined threshold.

In one embodiment, the step of performing a path random search and generation using arcs and straight lines which are connected smoothly in the main path generation step or the branch path generation step further includes: an assessment strategy optimization step of determining whether the currently generated main path or branch path meets a predetermined path usability condition in the case that this path has reached the map boundary; if the predetermined path usability condition is not met, the currently generated main path or branch path is cleared, and the main path or branch path generation step is performed again.

In one embodiment, the path usability condition includes the one that a path coverage rate of the currently generated main path or branch path is greater than a predetermined threshold.

In one embodiment, the path usability condition further includes the one that the length of the branch path is less than that of the main path length.

In one embodiment, in the main path generation step, the initial departure direction is perpendicular to one boundary of the map; and in the branch path generation step, the initial departure direction of the branch path is perpendicular to the direction of the main path at the intersection point.

According to another aspect of the present disclosure, there is further provided a device for generating a game path, including a processor and a storage, where the storage is configured to store computer instructions, and the processor is configured to execute computer instructions stored in the storage. When the processor executes the computer instructions stored on the storage, the device for generating a game path is configured to implement the above-mentioned method for generating a game path.

According to another aspect of the present disclosure, there is provided a computer program storage medium, on which a computer program code is stored.When the code is executed, the above-mentioned method for generating a game path is implemented.

Based on the technical solution of the present disclosure, a game level path is generated automatically by a computer, instead of human, with the advantages of high speed, low costs, automatic generation of game paths, and various defects in the traditional game path design are overcome.

### BRIEF DESCRIPTION OF THE DRAWINGS

The foregoing and other objects, features and advantages of the disclosure will become more apparent from the following description of embodiments of the disclosure in reference to the drawings.

FIG. 1 is an example of a method for representing a path using circular arcs according to some embodiments of the present disclosure.

FIG. 2 is a flow chart of a method for automatically generating a path of the Tower Defense Game according to one embodiment of the present disclosure.

FIG. 3 is a schematic diagram showing that a boundary is reached by a first search according to some embodiments of the present disclosure.

FIG. 4 is a schematic diagram of obtaining a complete path by double search according to some embodiments of the present disclosure.

FIG. 5 is a schematic diagram of a main path and a branch path according to some embodiments of the present disclosure.

FIG. 6 is a flow chart of a method for generating a main path according to some embodiments of the present disclosure.

FIG. 7 is a flow chart of a method for generating a branch path according to some embodiments of the present disclosure.

FIG. 8(a) is an example of a path of a level generated using a method for generating a path automatically according to some embodiments of the present disclosure.

FIG. 8(b) is an example of a path of a level generated using a method for generating a path automatically according to some embodiments of the present disclosure.

FIG. 8(c) is an example of a path of a level generated using a method for generating a path automatically according to some embodiments of the present disclosure.

FIG. 9 is a schematic block diagram of a device for generating a game path according to some embodiments of the present disclosure.

### DETAILED DESCRIPTION OF THE EMBODIMENTS

With reference to the following drawings, the embodiments of the present disclosure are explained. In the description and drawings, the illustrate embodiments of the present disclosure are disclosed in detail, and the principle of the present disclosure and the manners of use are indicated. It should be understood that the scope of the present disclosure is not limited thereto. The present disclosure contains many alternations, modifications and equivalents within the spirits and scope of the terms of the appended claims.

It shall be noted that a representation and a description of components and processes irrelevant to the disclosure and well known to those ordinarily skilled in the art will be omitted in the drawings and the description for the sake of clarity.

Features that are described and/or illustrated with respect to one embodiment may be used in the same way or in a similar way in one or more other embodiments and/or in combination with or instead of the features of the other embodiments.

It should be emphasized that the term “includes/including/comprises/comprising” when used in this specification is taken to specify the presence of stated features, integers, steps or components but does not preclude the presence or addition of one or more other features, integers, steps, components or groups thereof.

In order to solve the problems of low design efficiency, long design flow, high manpower and funding costs, and insufficient game contents due to abuse of randomness in the traditional game path design, there is provided a method for generating a large number of game paths automatically by a computer instead of human. As an exemplary embodiment, the present disclosure performs automatic search and generation of paths in the game based on MCTS (Monte Carlo Tree Search) Method, and optimizes the paths using a pruning strategy and an assessment strategy, thereby generating the game path rapidly and automatically with low costs, overcoming various defects in the traditional game path design, greatly improving the game generation efficiency, and increasing enjoyment and challenge of the game.

MCTS is a method for making an optimal decision in AI, usually a move planning form in a combined game. It is based on random or pseudorandom. The MCTS searches for a search space, scores the value of the search result when certain search depth is made, and performs screening and pruning technology according to the score of each node, in combination with universality of random simulation and accuracy of tree search. As a heuristic search strategy, the MCTS enlarges a search tree based on a random sample of the search space, thereby analyzing how to select in each step in the search task, so as to obtain an optimal result.

The MCTS may effectively search the random space and obtain the result with a high value. As a variant of the MCTS, the method according to the present disclosure may effectively solve the problem of random number abuse and the problem of an overlarge search space caused by random number abuse in the PCG method, and greatly improve the game path design efficiency and game enjoyment.

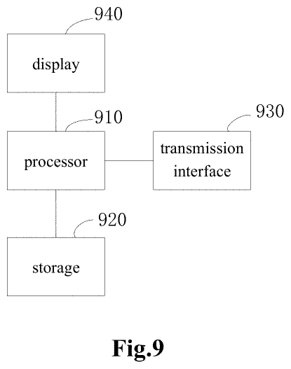

The method for generating a game path based on MCTS according to the embodiments of the present disclosure will be described below. This method for generating a game path may be implemented on computers, each of which has a storage and a processor. For example, the processor may be a CPU, a microprocessor, or the like, but not limited thereto. FIG. 9 is a schematic block diagram of a device for generating a game path according to embodiments of the present disclosure. The device includes a processor 910 and a storage 920. The storage 920 is configured to store a computer program, and the processor 910 implements the method for generating a game path by executing the computer program. Optionally, this device may further include a transmission interface (a wired interface or wireless network interface) 930 and a display 940. The transmission interface 930 is configured to communicate with an external device, to transmit data. The display 940 is configured to display the generated path in a map of the game. The structure shown in FIG. 9 is merely an example, and may include more or less parts.

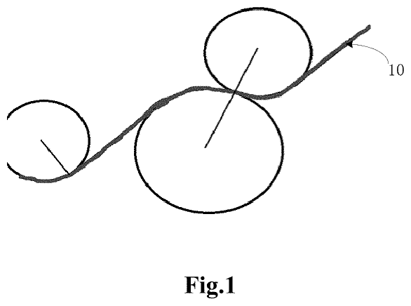

In the present disclosure, a method for representing a path is firstly proposed.That is, several different circular arcs and straight lines are “smoothly” connected, to represent a path. The so-called smooth connection means that each segment of circular arc or straight line is generated along the direction of the end of the former path. For example, the method for ensuring the smooth connection of arcs is as follows. When to generate a segment of arc, a curvature center of a circle of this arc is ensured to be on a perpendicular line perpendicular to a tangential direction at the end point of the former path. Based on this method, the game path information may be represented. FIG. 1 is a schematic diagram of a path representation method for representing a path 10 by smoothly connecting a circular arc and a straight line according to some embodiments of the present disclosure.

In the embodiments of the present disclosure, one main path and one or more branch paths may be generated on the game map. No matter the main path or the branch path, the step of generating each path may include the following three parts based on Monte Carlo Tree Search mechanism: the random search step, pruning strategy optimization step and assessment strategy optimization step. In the search process, the pruning strategy screens the search or path not matching the strategy requirement for each search, thereby improving path usability, reducing the number of times of search, and improving path generation efficiency. For example, the assessment strategy assesses the rationality of the path after the path is generated, thereby deciding whether this path is applied to the game.

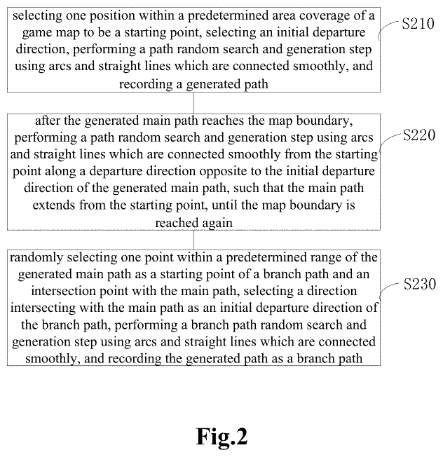

FIG. 2 is a flow chart of a method for automatically generating a game path according to one embodiment of the present disclosure. As shown in FIG. 2, this method may include main path generation steps S210-S220 and a branch path generation step S230, where the step S230 may be executed many times, to generate a plurality of branch paths.

In the present embodiment, only one path is set to be the main path, and other paths are considered as branches of the main path, i.e., branch paths. Therefore, one complete path generation process is defined to include one main path generation step and several branch path generation steps. In the main path generation step, the main path is formed by connecting two segments of paths smoothly generated by twice path searches.

In the step S210, a processor of a computer accesses the game map which is stored in the storage device of the computer, reads the position data such as coordinate data in the game map, and determines the edge location and the area coverage of the map. Then, the processor selects one position automatically within predetermined area coverage of a game map to be a starting point, selects an initial departure direction randomly, and performs a path random search and generation step using arcs and straight lines which are connected smoothly, and records a generated path as a first segment of the main path.

The above-mentioned predetermined area coverage for example may be a predetermined range of the central area of the map, and is not limited in the present disclosure.

As an example, the processor may select one position randomly within an area close to a map center as a starting point, select one direction randomly as an initial departure direction, and perform path random search using arcs and/or straight lines which are connected smoothly from the starting point and the initial departure direction. In the present example, the random selection of the starting point refers to selecting a point in an area close to the map center as a starting point according to a certain random possibility. The selection of the initial departure direction by the processor may also be performed according to a certain random possibility. In the path random search, the processor may record the point coordinates on the path every predetermined number of pixels (such as every 7 pixels, but not limited thereto), and a list including several point coordinates is taken as a path representation.

In addition, in the random search process, each automatic search by the processor may decide to use an arc or straight line to extend (prolong) the path according to a certain possibility. The straight line or arc used in each search may have fixed parameters, for example, a fixed length of the straight line, a fixed radian of the arc and a fixed radius, or have variable parameters. The map in the game has a fixed size. Parameters such as different combinations of arc radians and radiuses and straight line lengths can be set in advance via human-computer interaction interface and can be stored in a parameter library in the storage. In one embodiment, a plurality of paths can be generated in a plurality of experiments in each of which the processor obtains different parameters from the parameter library and randomly selects on the map based on the different parameters. Then the appropriate parameters may be selected as fixed parameters by judging preferable paths manually. Several groups of parameters related to the straight lines and arcs in the path, including straight line lengths, arc radiuses and arc radians, may also be selected manually and be recorded in the parameter library in the storage. In addition, preset parameter selection rules and random possibility of the parameter may also be stored in the storage. The subsequent path random search may be performed by the processor on basis of the preset parameter selection rule and the preset random possibility.

In some embodiments, a ratio of straight lines to arcs in a path may be preset via human-computer interaction interface and stored in the parameter library, such that when the path is searched, the preset ratio of straight lines to circular arcs is considered, and the parameters of the straight lines or arcs of the current search are obtained from the parameter library randomly based on the ratio.

In some embodiments, each path random search step performed by the processor may include generating a segment of arc or straight line along the current departure direction. The path random search may be performed many times to extend the path, until the path reaches the map boundary, thereby generating the first segment of main path in the main path.

Optionally, in the process of generating the first segment of main path, after each path random search, in the present disclosure the processor may further screen the search path not meeting requirement based on a predetermined pruning strategy, thereby improving the path generation efficiency. The predetermined pruning strategy may be stored in the storage. That is, besides the path search step, the step of performing path random search and generation using arcs and straight lines which are connected smoothly further includes a pruning strategy optimization step in which the processor determines whether the generated arc or straight line meets the predetermined pruning condition. If yes, the latest arc or straight line is undone, and the path generation step is performed again. As one example, the pruning strategy for example may include: generating a closed-loop path in the path. The closed-loop path means that newly generated path is intersected with exiting path and so a closed path is generated. In this way, in each search, it may be detected whether the random search generates a closed loop with the determined path; if yes, the state of this path may be reduced to the one before this search, and the searched new path is undone. Then, the path to be searched is further selected randomly again according to a certain possibility. In another embodiment of the present disclosure, the pruning strategy may also include: the currently generated path coincides with the existing path. In addition, the pruning strategy optimization step may further include: deleting the generated whole path, returning to the starting step in the random search, selecting the starting point again and generating a new path, if the number of times of withdrawing exceeds a certain value and a full path cannot be generated in the process of generating a path once, which may avoid the search algorithm from converging to be infeasible, and from generating an unreasonable path. Herein, the full path means the generated path which has reached the edge of the map.

In one embodiment, the step of performing path random search and generation further includes: an assessment strategy optimization step performed by the processor, where in the case that the currently generated main path or branch path has reached the map boundary, it is determined by the processor whether this path meets the predetermined path usability condition; if not, clearing the currently generated main path or branch path, and performing the main path or branch path generation step again. The path usability condition may be stored in the storage. As an example, the path usability condition includes the one that the coverage rate of the currently generated main path or branch path is greater than the predetermined threshold.

In one example, the whole map may be divided into n*m areas equally (n and m are natural numbers larger than or equal to 2, and may be the same or different), for example, a 4*4 area, the statistics on the number of areas where the path passes is done, and the ratio of the number of areas where the path passes to the number of all areas is calculated as a path coverage rate. If the path coverage rate is greater than the predetermined threshold, it is considered that the currently generated path is qualified, otherwise the currently generated path is deleted, and a new path is generated. The preset threshold of the path coverage rate for example, may be 50%-80%, preferably 75%. However, the present disclosure is not limited to this exemplary threshold, but may be more or less.

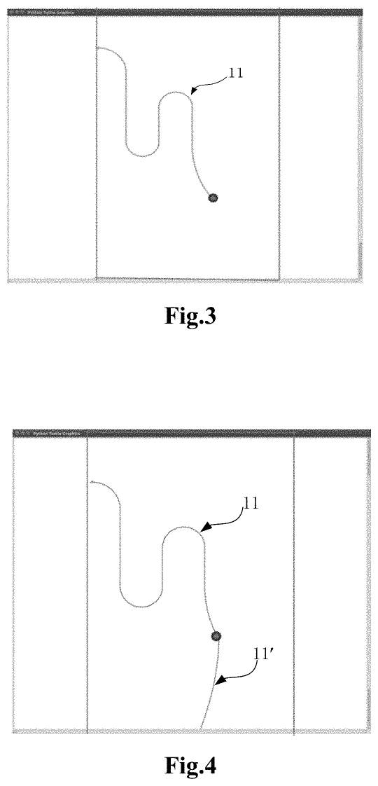

FIG. 3 is a schematic diagram of a first segment 11 of the main path generated after the step S210.

In the step S220, after the first segment 11 of the main path is generated, the path random search and generation step may be performed using arcs and straight lines connected smoothly from the starting point along a second initial departure direction opposite to the initial departure direction in the step S210 (the first initial departure direction), and the generated path is recorded as the second segment 11′ of the main path, until the map boundary is reached again, as shown in Fig.4.

In this step, except for the second initial departure direction opposite to the first initial departure direction, others may be performed with reference to the step 5210.

In this step, the step of performing path random search and generation using arcs and straight lines which are connected smoothly may be the same as the former step 5210, and is not repeated herein.

FIG. 4 is a schematic diagram of a full main path generated after the second search in step 5220. The full main path includes the first segment 11 of the main path and the second segment 11′ of the main path.

In another embodiment of the present disclosure, the main path may also be generated only using the random search operation once. At this point, the starting point may be selected at the boundary of the game map, and the initial departure direction may also be set to be perpendicular to the boundary where the starting point is located preferably. Other operations may refer to the step 5210, which are not repeated herein.

In the step 5230, the branch path is generated. In this step, one point is randomly selected within a predetermined range of the generated main path as an intersection point of a branch path starting point and the main path, a direction intersecting with the main path is selected as a branch path initial departure direction, a branch path random search and generation step is performed using arcs and straight lines which are connected smoothly, and the generated path is recorded as a branch path.

As one example, preferably, the initial departure direction of the branch path is designed to be perpendicular to the direction of the main path at the intersection point, but the present disclosure is not limited thereto.

In the branch path generation step, except for the fact that the starting point and the initial departure direction are different from those in the main path generation step, other operations may be the same as those in the main path generation step. For example, the step of branch path random search and generation using arcs and straight lines which are connected smoothly may also include a path random search step, a pruning strategy optimization step and an assessment strategy optimization step, where the operation rules of the path random search step, the pruning strategy optimization step and the assessment strategy optimization step may be the same as those of the main path generation step, and are not repeated herein.

Alternatively, in this step, in the assessment strategy optimization step, there may also be an additional path usability condition, which may include the one that the branch path length is less than the main path length, to ensure that the main path is longer than the branch path.

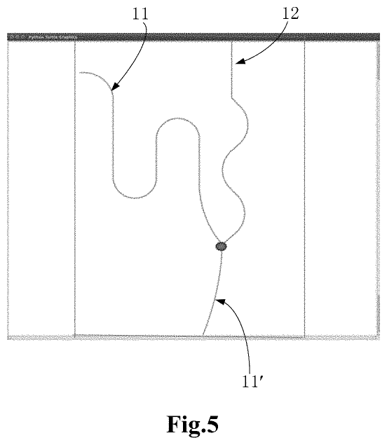

FIG. 5 is a schematic diagram of the main path and the branch path obtained in the embodiments of the present disclosure. As shown in FIG. 5, except for the main path 11 and 11′, the branch path 12 is also formed.

In the embodiment of the present disclosure, the whole generation process of the path may be taken as a variant using the MCTS algorithm. The process of generating one path is as follows. Firstly, one starting point and one initial direction are selected in the map, and then through the random search, segments are added to the current path step by step until the boundary is reached. In the random search process, it is detected whether the pruning condition and the ending condition are met. If the pruning condition is met, this generated path is withdrawn, and a new path is generated from the former segment. If the ending condition is met, the current path is passed to the strategy assessment to assess whether it is reasonable. If yes, the path is generated from the head.

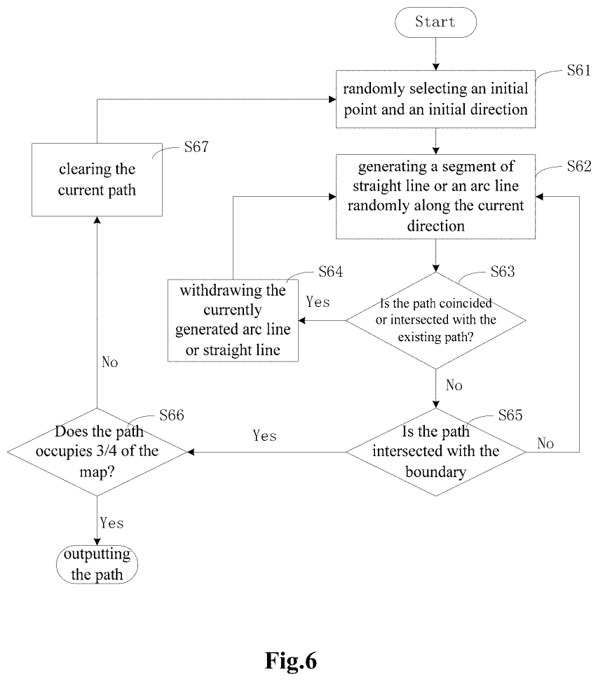

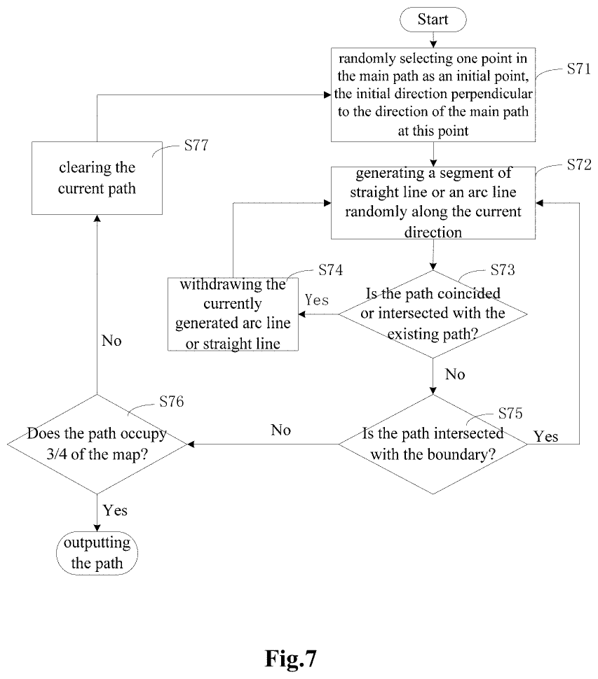

FIG. 6 is a flow chart of a method for generating a main path according to some embodiments of the present disclosure. FIG. 7 is a flow chart of a method for generating a branch path according to some embodiments of the present disclosure.

As shown in FIG. 6, the process of forming the main path in this example includes the following steps.

In the step S61, the processor of a computer accesses the game map and selects an initial point and an initial direction randomly in an area close to a central point of the map.

The map is designed as a rectangle of 1048×768, and is divided into four quadrants. A coverage rate counter (area count) is initialized, for calculating the number of quadrants where the generated path appears, thereby determining the coverage rate of the path. In other embodiments of the present disclosure, the map may also be divided into more areas equally, instead of only four quadrants, for example n*m (n>2, m>2) rectangular blocks. The coverage rate of the path is determined by judging the number of rectangular blocks occupied by the path.

The center point is defined as a point at a geometrical center of the rectangular map. The area close to the center point is defined as a circular area with the center point as the center of a circle and R (R ranges from 0 to half of a map width) as a radius.

The processor may select one point close to the center randomly as the starting point (such as the dot in FIG. 3) according to a certain possibility, and set the initial direction of the starting point to be perpendicular to an edge.

In the step S62, a segment of straight line or an arc with a radius of curvature of r and a radian of a is selected by the processor according to one possibility distribution which is set in advance. If the arc is selected, the arc needs to be in accordance with the current heading direction.

In the process of path generation, the configuration information such as the arc radius, radian and straight line length and a proportion of the straight lines to the arcs may be adjusted flexibly via human-computer interaction interface.

In the step S63, the pruning strategy optimization is performed by the processor on the generated path, and it is judged whether the currently generated path is coincided or intersected with the existing path.

If the currently generated path is neither coincided nor intersected with the existing path, the processor continues with the step S65. If the currently generated path is coincided or intersected with the existing path, the step S64 is executed by the processor, the currently generated arc or straight line is withdrawn, and the process returns to the step S62 to generate a segment of arc or straight line again.

In the step S65, it is judged by the processor whether the generated path is intersected with the map boundary (that is to judge whether the boundary is reached). If yes, it means that a full path is generated, and then the step S66 is performed, where the assessment strategy optimization is performed on the generated path, and it is judged whether the coverage rate of the currently generated main path or branch path is greater than the predetermined threshold. In the present embodiment, the predetermined threshold may take the value of ¾. That is, the path occupies three of the four quadrants. This predetermined threshold may be amended.

In the present embodiment, whether the path occupies ¾ of the map is determined by whether the value of a coverage rate counter is greater than 3.

If it is determined that the path occupies ¾ of the map, it is determined that the path is usable and then the path is output by the processor and is displayed on the game map via display of the computer.

If the path does not occupy ¾ of the map, the step S67 is performed by the processor, the currently generated whole path is deleted (cleared), and the step S61 is returned to generate a new path.

With the above-mentioned flow in FIG. 6, the main path can be generated. The exemplary generation flow of the branch path is described below. As shown in FIG. 7, the process of forming the branch path in this example includes the following steps.

In the step S71, the processor of a computer accesses the game map and selects one point randomly in a certain range on the generated path as an initial point, and an initial direction is set to be perpendicular to the direction of the main path at this point.

In the step S72, the processor selects a segment of straight line or an arc with a radius of curvature of r and a radian of a according to one possibility distribution which is set in advance. If the arc is selected, the arc needs to be in accordance with the current heading direction.

In the process of path generation, the configuration information such as the arc radius, radian and straight line length and a proportion of the straight lines to the arcs may be adjusted flexibly.

In the step S73, the processor performs the pruning strategy optimization on the generated path, and judges whether the currently generated path is coincided or intersected with the existing path.

If the currently generated path is neither coincided nor intersected with the existing path, the processor continues with the step S75. If the currently generated path is coincided or intersected with the existing path, the step S74 is executed by the processor, the currently generated arc or straight line is withdrawn, and the process returns to the step S72 to generate a segment of arc or straight line again.

In the step S75, the processor judges whether the generated path is intersected with the map boundary (that is to judge whether the boundary is reached). If yes, it means that a full path is generated, and then the step S76 is performed, where the assessment strategy optimization is performed on the generated path, and it is judged whether the path length is greater than a predetermined threshold and less than the main path length. If the path length of the generated branch is less than the main path length and greater than the set predetermined threshold, it is determined that the path is usable, and then the path is output by the processor and is displayed on the game map via display of the computer.

If the path length of the generated branch is greater than the main path length or less than the set predetermined threshold, the step S77 is performed, the currently generated whole path is deleted (cleared), and the step S71 is returned to generate a new path.

With the above-mentioned flow in FIG. 7, the branch path can be generated.

In the above-mentioned method steps according to the present disclosure, some steps may be executed in parallel or in an exchanged order, and the present disclosure is not limited to the shown order.

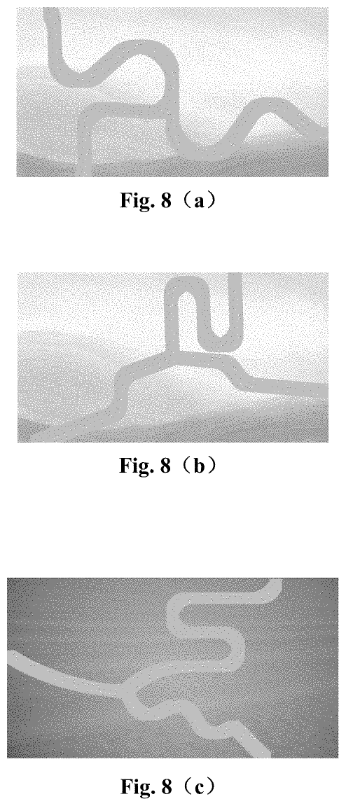

(a)-(c) in FIG. 8 are examples of game level paths generated by the method according to the present disclosure. The generated main path and branch path can displayed on the map of the as a new part of the map.

In the embodiments of the present disclosure, the pruning strategy and the assessment strategy may be flexibly set or amended.

In the present disclosure, with the above-designed path generation algorithm, a computer can be used to generate a path automatically, and the generation stage does not need human, which greatly saves human resources. The path generation speed is high and the game production efficiency is improved greatly. Moreover, by fitting path using several straight lines and arcs, natural path effects may be generated.

In the present disclosure, the MCRS method is used to extend the path, and in combination with the pruning strategy and the assessment strategy, the random abuse problem in the original PCG technology may be alleviated by replacing the way of generating game contents randomly in the PCG. With an analysis on paths of popular games on the market, some modes of constitute elements of paths are obtained. With combined use of the pruning strategy and the assessment strategy, generation of a large number of paths and their reasonability in case of random are ensured, thereby ensuring the playability and challenge of the game. The method according to the present disclosure is not only applied to the generation of the level path of the Tower Defense Game, but also used for other games where path design is needed.

The above-mentioned method of the embodiments of the present disclosure may be implemented by executing the computer program on the computer. Therefore, the present disclosure provides a device for generating a game path, including a processor and a storage, where the storage is configured to store computer instructions, and the processor is configured to execute computer instructions stored in the storage. When the processor executes the computer instructions stored on the storage, the device for generating a game path is configured to implement the above-mentioned method for generating a game path.

The present disclosure also relates to a storage medium, on which a computer program code is stored. When the program code is executed, various embodiments of the method for generating game paths according to the present disclosure may be implemented. The storage medium may be a tangible storage medium, such as an optical disk, USB flash disk, soft disk, a hard disk, or the like.

Persons skilled in the art may realize that each exemplary unit and method step described in combination with the disclosed embodiment herein may be implemented by hardware, software or the combination of hardware and software. Whether these functions are executed by way of hardware or software depends on the particular application and design constraints of the technical solution. Those skilled in the art can use different methods for each specific application to achieve the described functions, however, such implementations should not be considered as exceeding the scope of the present disclosure.

The steps of the method or algorithm described in combination with the embodiments of the present disclosure herein may be implemented by software executed by hardware (a logic device such as a computer). When the software is executed, the above-mentioned method or its steps may be implemented by the hardware (a logic device such as a computer), or the hardware (a logic device such as a computer) serves as the device part of the above-mentioned present disclosure.

The software may be built in RAM, memory, ROM, electrically programmable ROM, electrically erasable programmable ROM, register, hard disk, movable magnetic disk, CD-ROM, or any other forms of non-volatile storage mediums well-known in the art.

The foregoing embodiments are merely exemplary, not to limit the present disclosure. Various variants and modifications may be made by those skilled in the art according to the spirits of the present disclosure, and such variants and modifications fall within the scope of the present disclosure.

What is claimed is:

1. A method for generating a game path, comprising a main path generation step and at least one branch path generation step:
Wherein the main path generation step comprises:
selecting one position within predetermined area coverage of a game map to be a starting point, selecting an initial departure direction, performing a path random search and generation step using arcs and straight lines which are connected smoothly, and recording a generated path as a main path, until a map boundary is reached;
the branch path generation step comprises:
randomly selecting one point within a predetermined range of the generated main path as a starting point of a branch path and an intersection point with the main path, selecting a direction intersecting with the main path as an initial departure direction of the branch path, performing a branch path random search and generation step using arcs and straight lines which are connected smoothly, and recording the generated path as a branch path.

2. The method according to claim 1, wherein the predetermined area coverage of the game map is in the middle of the game map;
the main path generation step further comprises: after the generated main path reaches the map boundary, performing a path random search and generation step using arcs and straight lines which are connected smoothly from the starting point along a departure direction opposite to the initial departure direction of the generated main path, such that the main path extends from the starting point, until the map boundary is reached again.

3. The method according to claim 1, wherein the step of performing path random search and generation using arcs and straight lines which are connected smoothly in the main path generation step or the branch path generation step comprises:
a path search step, for generating a segment of arc or straight line along the current departure direction; and
a pruning strategy optimization step, for determining whether the generated arc or straight line meets the predetermined pruning condition; if yes, the latest arc or straight line is undone, and the path generation step is performed again.

4. The method according to claim 3, wherein
the pruning condition comprises: coinciding or intersecting with the existing path.

5. The method according to claim 3, wherein the pruning strategy optimization step further comprises:
deleting a path if the number of times of undoing arcs or straight lines in the process of path generation exceeds a predetermined threshold.

6. The method according to claim 1, wherein the step of performing a path random search and generation using arcs and straight lines which are connected smoothly in the main path generation step or the branch path generation step further comprises:
an assessment strategy optimization step, for determining whether the currently generated main path or branch path meets a predetermined path usability condition in the case that this path has reached the map boundary; if the predetermined path usability condition is not met, the currently generated main path or branch path is cleared, and the main path or branch path generation step is performed again.

7. The method according to claim 6, wherein
the path usability condition comprises the one that a path coverage rate of the currently generated main path or branch path is greater than a predetermined threshold.

8. The method according to claim 7, wherein
the path usability condition further comprises the one that the length of the branch path is less than that of the main path.

9. The method according to claiml, wherein
in the main path generation step, the initial departure direction is perpendicular to one boundary of the map; and
in the branch path generation step, the initial departure direction of the branch path is perpendicular to the direction of the main path at the intersection point.

10. A device for generating a game path, comprising a processor and a storage, where the storage is configured to store computer instructions, and the processor is configured to execute computer instructions stored in the storage; when the processor executes the computer instructions stored on the storage, the device for generating a game path is configured to implement the method for generating a game path according to claim 1.

11. A computer program storage medium, on which a computer program code is stored; when the code is executed, the method for generating a game path according to claim 1 is implemented.
